(19) United States
(12) Patent Application Publication
(10) Pub. No.: US 2008/0033617 A1
(43) Pub. Date: Feb. 7, 2008

(54) Motor Vehicle And Control Method Of The Same

(76) Inventors: Hideto Watanabe, Aichi-ken (JP); Keijiro Oshima, Aichi-ken (JP)

Correspondence Address: KENYON & KENYON LLP, 1500 K STREET N.W., SUITE 700, WASHINGTON, DC, 20005, US

(21) Appl. No.: 11/660,683

(22) PCT Filed: Aug. 11, 2005
(86) PCT No.: PCT/JP05/15040

§ 371 Date: Feb. 21, 2007

(30) Foreign Application Priority Data
Sep. 1, 2004 (JP) 2004-254352

(51) Int. Cl. G06F 17/00; B60K 23/00

(52) U.S. Cl. 701/48; 180/338

(57) ABSTRACT

In response to a brake OFF operation (step S110) after a gearshift operation of a gearshift lever to a parking position, a motor is controlled to output a torque corresponding to an adjusted driving force F*, which is applied in a direction of canceling a force component of a vehicle weight M acting in a longitudinal direction of a motor vehicle based on a measured road surface gradient θ (steps S120 to S180). Such control reduces the force applied in the longitudinal direction of the vehicle and decreases the moving speed of the vehicle. The decreased moving speed of the vehicle enables moderate engagement of gears in a parking lock mechanism to decrease the potential shock of gear engagement and reduces the driver's feeling of idle running.

### TECHNICAL FIELD

The present invention relates to a motor vehicle and a control method of the motor vehicle.

### BACKGROUND ART

A proposed parking mechanism mounted on a motor vehicle includes a parking gear that is attached to an output shaft connected to an axle of the vehicle and a parking pole that engages with the parking gear and locks the parking gear in a non-rotatable state (see, for example, Japanese Patent Laid-Open Gazette No. H10-278758). Gear engagement of the parking mechanism locks the axle of the motor vehicle.

### DISCLOSURE OF THE INVENTION

The driver of this prior art motor vehicle may feel a shock of gear engagement in the parking mechanism. When the driver releases a brake pedal on a slope after a gearshift operation of a gearshift lever to a parking position, the vehicle is kept at a stop under the condition of gear engagement of the parking mechanism. Under the condition of gear disengagement of the parking mechanism, however, the force component of the vehicle weight acting in the longitudinal direction of the vehicle moves the vehicle to the timing of gear engagement. Such motion of the vehicle gives the driver an unexpected shock of gear engagement and unexpected feeling of idle running.

The motor vehicle and the motor vehicle control method of the invention aim to reduce the potential shock of gear engagement in a locking structure, such as a parking lock. The motor vehicle and the motor vehicle control method of the invention also aim to reduce the driver's feeling of idle running when the driver's depression amount of a brake pedal becomes less than a preset level after a gearshift operation of a gearshift lever to a parking position.

At least part of the above and the other related objects is attained by a motor vehicle and control method of the motor vehicle of the invention having the configurations discussed below.

The present invention is directed to a first motor vehicle and the first motor vehicle includes: a motor that outputs driving force to drive the motor vehicle; a locking structure that utilizes gear engagement to lock an axle of the motor vehicle in a non-rotatable state; an adjusted driving force setting module that sets an adjusted driving force, which is smaller than a vehicle weight force component or a force component of a vehicle weight acting in a longitudinal direction of the motor vehicle based on a road surface gradient and is applied in a direction of canceling the vehicle weight force component; and a control module that, when a driver's depression amount of a brake pedal becomes less than a preset level to move the motor vehicle in the acting direction of the vehicle weight force component after a gearshift operation of a gearshift lever to a parking position, controls the motor to output the adjusted driving force and controls the locking structure to lock the axle.

When the driver's depression amount of the brake pedal becomes less than the preset level to move the motor vehicle in the acting direction of the vehicle weight force component after a gearshift operation of the gearshift lever to the parking position, the first motor vehicle of the invention controls the motor to output the adjusted driving force, which is smaller than the vehicle weight force component acting in the longitudinal direction of the motor vehicle based on the road surface gradient and is applied in the direction of canceling the vehicle weight force component, while controlling the locking structure to lock the axle in the non-rotatable state. The motor is controlled to output the adjusted driving force based on the road surface gradient. Such control reduces the force applied in the longitudinal direction of the vehicle and decreases the moving speed of the vehicle in the acting direction of the vehicle weight force component. The decreased moving speed of the vehicle enables moderate locking of the locking structure by gear engagement to decrease the potential shock of gear engagement and reduces the driver's feeling of idle running.

In the first motor vehicle of the invention, the control module may control the motor to output the adjusted driving force when the driver's depression amount of the brake pedal becomes less than the preset level within a predetermined time period since the gearshift operation of the gearshift lever to the parking position.

In the first motor vehicle of the invention, the control module may control the motor to terminate the output of the adjusted driving force when a predetermined condition is satisfied. In this case, the predetermined condition may be that a measured vehicle speed of the motor vehicle becomes less than a preset vehicle speed, and the predetermined condition may also be that a rotational angle of a drive shaft linked to the axle is kept unchanged in a specified angle range. The gear engagement of the locking structure is estimated according to the vehicle speed or according to the rotational angle of the drive shaft. The output of the adjusted driving force from the motor is terminated, based on the result of estimation. The predetermined condition may be that a measured vehicle speed of the motor vehicle becomes less than a preset vehicle speed, that a rotational angle of a drive shaft linked to the axle is kept unchanged in a specified angle range, or that a predetermined time period has elapsed since a start of the output of the adjusted driving force from the motor.

In the first motor vehicle of the invention, the adjusted driving force setting module may measure the road surface gradient and set the adjusted driving force to increase with an increase in measured road surface gradient. In the first motor vehicle of the invention, the adjusted driving force setting module may measure the vehicle weight force component and set the adjusted driving force to increase with an increase in measured vehicle weight force component. These arrangements ensure adequate setting of the adjusted driving force and effectively reduce the potential shock of gear engagement in the locking structure.

In one preferable embodiment of the invention, the first motor vehicle further includes a second motor that outputs driving force to a different axle from the axle receiving the driving force output from the motor. The control module controls the motor and the second motor to cooperatively output the adjusted driving force. The motor and the second motor are controlled to cooperatively output the adjusted driving force. This effectively reduces the potential shock of gear engagement in the locking structure.

The present invention is also directed to a second motor vehicle and the second motor vehicle includes: multiple motors that output driving force to an identical axle or to different axles to drive the motor vehicle; a locking structure that utilizes gear engagement to lock an axle of the motor vehicle in a non-rotatable state; an adjusted driving force setting module that sets an adjusted driving force, which is smaller than a vehicle weight force component or a force component of a vehicle weight acting in a longitudinal direction of the motor vehicle based on a road surface gradient and is applied in a direction of canceling the vehicle weight force component; and a control module that, when a driver's depression amount of a brake pedal becomes less than a preset level to move the motor vehicle in the acting direction of the vehicle weight force component after a gearshift operation of a gearshift lever to a parking position, controls the multiple motors to ensure output of the adjusted driving force from at least one of the multiple motors and controls the locking structure to lock the axle.

When the driver's depression amount of the brake pedal becomes less than the preset level to move the motor vehicle in the acting direction of the vehicle weight force component after a gearshift operation of the gearshift lever to the parking position, the second motor vehicle of the invention controls the multiple motors to ensure output of the adjusted driving force from at least one of the multiple motors, while controlling the locking structure to lock the axle in the non-rotatable state. The adjusted driving force is smaller than the vehicle weight force component acting in the longitudinal direction of the motor vehicle based on the road surface gradient and is applied in the direction of canceling the vehicle weight force component. At least one of the multiple motors is controlled to output the adjusted driving force based on the road surface gradient. Such control reduces the force applied in the longitudinal direction of the vehicle and decreases the moving speed of the vehicle in the acting direction of the vehicle weight force component. The decreased moving speed of the vehicle enables moderate locking of the locking structure by gear engagement to decrease the potential shock of gear engagement and reduces the driver's feeling of idle running.

The present invention is also directed to a control method of a first motor vehicle equipped with a motor that outputs driving force to drive the motor vehicle and a locking structure that utilizes gear engagement to lock an axle of the motor vehicle in a non-rotatable state. The control method of the first motor vehicle includes the steps of: (a) setting an adjusted driving force, which is smaller than a vehicle weight force component or a force component of a vehicle weight acting in a longitudinal direction of the motor vehicle based on a road surface gradient and is applied in a direction of canceling the vehicle weight force component; and (b) when a driver's depression amount of a brake pedal becomes less than a preset level to move the motor vehicle in the acting direction of the vehicle weight force component after a gearshift operation of a gearshift lever to a parking position, controlling the motor to output the adjusted driving force and controlling the locking structure to lock the axle.

When the driver's depression amount of the brake pedal becomes less than the preset level to move the motor vehicle in the acting direction of the vehicle weight force component after a gearshift operation of the gearshift lever to the parking position, the control method of the first motor vehicle of the invention controls the motor to output the adjusted driving force, which is smaller than the vehicle weight force component acting in the longitudinal direction of the motor vehicle based on the road surface gradient and is applied in the direction of canceling the vehicle weight force component, while controlling the locking structure to lock the axle in the non-rotatable state. The motor is controlled to output the adjusted driving force based on the road surface gradient. Such control reduces the force applied in the longitudinal direction of the vehicle and decreases the moving speed of the vehicle in the acting direction of the vehicle weight force component. The decreased moving speed of the vehicle enables moderate locking of the locking structure by gear engagement to decrease the potential shock of gear engagement and reduces the driver's feeling of idle running.

In the control method of the first motor vehicle of the invention, the step (b) may control the motor to output the adjusted driving force when the driver's depression amount of the brake pedal becomes less than the preset level within a predetermined time period since the gearshift operation of the gearshift lever to the parking position. The step (b) may control the motor to terminate the output of the adjusted driving force when a predetermined condition is satisfied.

Further, in the control method of the first motor vehicle of the invention, the step (a) may measure the road surface gradient and set the adjusted driving force to increase with an increase in measured road surface gradient. The step (a) may measure the vehicle weight force component and set the adjusted driving force to increase with an increase in measured vehicle weight force component.

The present invention is also directed to a control method of a second motor vehicle equipped with multiple motors that output driving force to an identical axle or to different axles to drive the motor vehicle and a locking structure that utilizes gear engagement to lock an axle of the motor vehicle in a non-rotatable state. The control method of the second motor vehicle includes the steps of: (a) setting an adjusted driving force, which is smaller than a vehicle weight force component or a force component of a vehicle weight acting in a longitudinal direction of the motor vehicle based on a road surface gradient and is applied in a direction of canceling the vehicle weight force component; and (b) when a driver's depression amount of a brake pedal becomes less than a preset level to move the motor vehicle in the acting direction of the vehicle weight force component after a gearshift operation of a gearshift lever to a parking position, controlling the multiple motors to ensure output of the adjusted driving force from at least one of the multiple motors and controlling the locking structure to lock the axle.

When the driver's depression amount of the brake pedal becomes less than the preset level to move the motor vehicle in the acting direction of the vehicle weight force component after a gearshift operation of the gearshift lever to the parking position, the control method of the second motor vehicle of the invention controls the multiple motors to ensure output of the adjusted driving force from at least one of the multiple motors, while controlling the locking structure to lock the axle in the non-rotatable state. The adjusted driving force is smaller than the vehicle weight force component acting in the longitudinal direction of the motor vehicle based on the road surface gradient and is applied in the direction of canceling the vehicle weight force component. At least one of the multiple motors is controlled to output the adjusted driving force based on the road surface gradient. Such control reduces the force applied in the longitudinal direction of the vehicle and decreases the moving speed of the vehicle in the acting direction of the vehicle weight force component. The decreased moving speed of the vehicle enables moderate locking of the locking structure by gear engagement to decrease the potential shock of gear engagement and reduces the driver's feeling of idle running.

### BRIEF DESCRIPTION OF THE DRAWINGS

FIG. 1 schematically illustrates the configuration of an electric vehicle in one embodiment of the invention;

FIG. 2 is a flowchart showing a parking lock control routine executed by an electronic control unit mounted on the electric vehicle of the embodiment;

FIG. 3 shows a coefficient setting map;

FIG. 4 shows a relation between a vehicle weight force component FM and an adjusted driving force F* at a road surface gradient θ;

FIG. 5 is a flowchart showing a modified parking lock control routine;

FIG. 6 schematically illustrates the configuration of another electric vehicle in one modified example;

FIG. 7 schematically illustrates the configuration of a hybrid vehicle in another modified example; and

FIG. 8 schematically illustrates the configuration of another hybrid vehicle in still another modified example.

### BEST MODE OF CARRYING OUT THE INVENTION

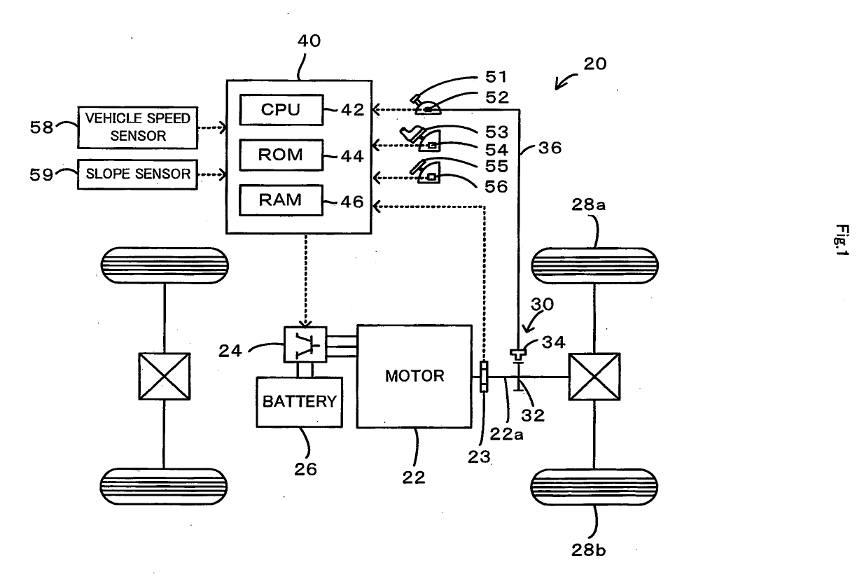

One mode of carrying out the invention is described below as a preferred embodiment. FIG. 1 schematically illustrates the configuration of an electric vehicle 20 in one embodiment of the invention. As shown in FIG. 1, the electric vehicle 20 of the embodiment includes a drive motor 22 that is a known synchronous motor generator and utilizes a supply of electric power from a battery 26 via an inverter 24 to output driving force to drive wheels 28a and 28b, a parking lock mechanism 30 that locks the drive wheels 28a and 28b, and an electronic control unit 40 that controls the operations of the whole electric vehicle 20.

The parking lock mechanism 30 includes a parking gear 32 that is attached to a rotating shaft 22a of the motor 22 functioning as a drive shaft linked to the drive wheels 28a and 28b, and a parking lock pole 34 that engages with the parking gear 32 to lock the parking gear 32 in a non-rotatable state. The parking lock pole 34 is activated by transmission of a gearshift operation of a gearshift lever 51 from another gear position to a parking position (P position) or a gearshift operation from the P position to another gear position via a shift cable 36. The parking lock pole 34 engages with and disengages from the parking gear 32 to activate and release the parking lock.

The electronic control unit 40 is constructed as a microprocessor including a CPU 42, a ROM 44 that stores processing programs, a RAM 46 that temporarily stores data, and input and output ports (not shown). The electronic control unit 40 receives, via its input port, a rotational angle α of the rotating shaft 22a of the motor 22 as the drive shaft from a rotational angle sensor 23, a gearshift position SP currently set by the gearshift lever 51 from a gearshift position sensor 52, an accelerator opening Acc or the driver's depression amount of an accelerator pedal 53 from an accelerator pedal position sensor 54, a brake pedal position BP or the driver's depression amount of a brake pedal 55 from a brake pedal position sensor 56, a vehicle speed V of the electric vehicle 20 from a vehicle speed sensor 58, and a road surface, gradient θ in the longitudinal direction of the electric vehicle 20 from a slope sensor 59. The electronic control unit 40 outputs, via its output port, switching control signals to switching elements of the inverter 24 to drive and control the motor 22.

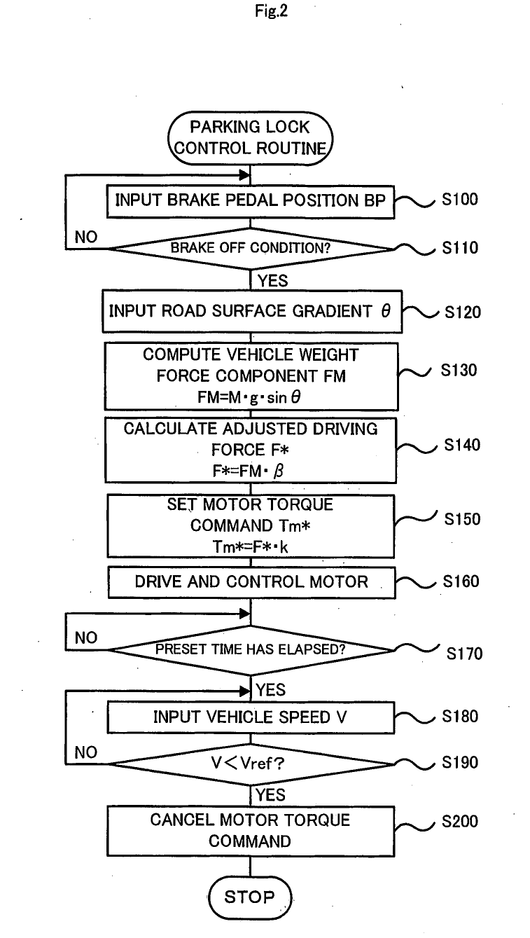

The following description regards the operations of the electric vehicle 20 of the embodiment configured as discussed above, especially a series of control in response to a gearshift operation of the gearshift lever 51 to the P position during a stop of the electric vehicle 20. FIG. 2 is a flowchart showing a parking lock control routine executed by the electronic control unit 40. This routine is triggered by a gearshift operation of the gearshift lever 51 to the P position.

In the parking lock control routine, the CPU 42 of the electronic control unit 40 first inputs the brake pedal position BP from the brake pedal position sensor 56 (step S100), and waits for a brake OFF operation, which makes the input brake pedal position BP equal to 0% (step S110).

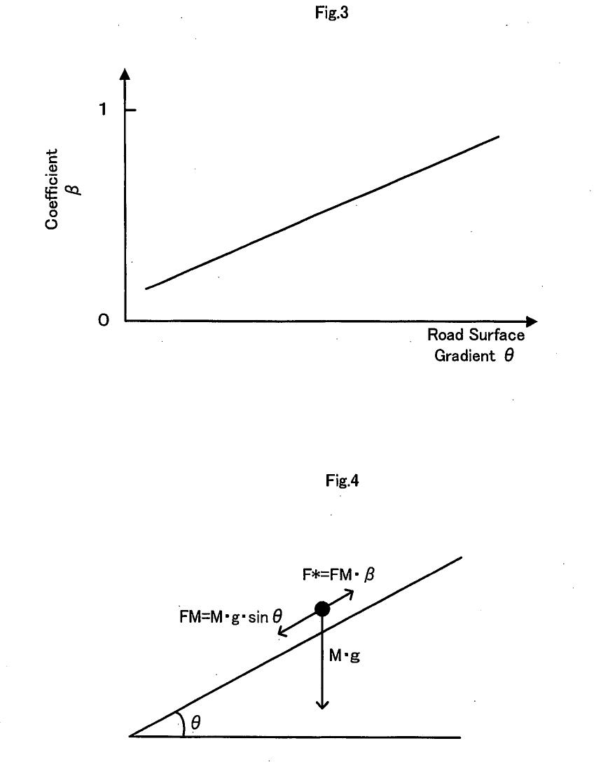

In response to the brake OFF operation, the CPU 42 inputs the road surface gradient θ from the slope sensor 59 (step S120) and computes a vehicle weight force component FM (=M·g·sin θ), which is a force component of a vehicle weight M in the longitudinal direction of the electric vehicle 20, from the input road surface gradient θ and the gravity acceleration g (step S130). The CPU 42 then multiples the computed vehicle weight force component FM by a preset coefficient β, so as to calculate an adjusted driving force F* applied in a direction of canceling the vehicle weight force component FM (step S140). In this embodiment, the vehicle weight M represents the total weight of the electric vehicle 20 with a driver. The coefficient β is used to determine the reduction degree of the force applied in the longitudinal direction of the electric vehicle 20. The procedure of this embodiment stores in advance a variation in coefficient β against the road surface gradient θ as a coefficient setting map in the ROM44 and reads the coefficient β corresponding to the given road surface gradient θ from the coefficient setting map. FIG. 3 shows one example of the coefficient setting map. The coefficient β is set to increase in a range of 0 to 1 with an increase in road surface gradient θ. Such setting interferes with an increase in force in the longitudinal direction of the vehicle according to the vehicle weight force component FM and the adjusted driving force F* with an increase in road surface gradient θ. FIG. 4 shows the relation between the vehicle weight force component FM and the adjusted driving force F* at the road surface gradient θ.

The CPU 42 then multiples the adjusted driving force F* by a conversion factor k for converting the driving force into a torque of the motor 22 to set a torque command Tm* of the motor 22 (step S150), and drives and controls the motor 22 to output a torque equivalent to the torque command Tm* (step S160). In response to the brake OFF operation after the gearshift operation of the gearshift lever 51 to the P position, the motor 22 is controlled to output a torque corresponding to the adjusted driving force F* applied in the direction of canceling the vehicle weight force component FM and thereby reduce the force applied in the longitudinal direction of the vehicle. This control decreases the moving speed of the vehicle under the condition of disengagement of the gears in the parking lock mechanism 30 at the brake OFF timing. The decreased moving speed of the vehicle enables moderate engagement of the gears in the parking lock mechanism 30 to decrease the potential shock of gear engagement and reduces the driver's feeling of idle running.

After elapse of a preset time period tref (step S170), the CPU 42 inputs the vehicle speed V from the vehicle speed sensor 58 (step S180) and compares the input vehicle speed V with a preset reference value Vref (step S190). When the vehicle speed reaches or exceeds the preset reference value Vref, the parking lock control routine returns to step S180. The reference time tref is set to be equal to or slightly longer than a required time period for detection of a motion of the vehicle after the brake OFF operation. The reference time tref is generally set to a time period required to increase the vehicle speed V to or over the preset reference value Vref, for example, several tens to several hundreds msec. The reference value Vref is used as a criterion to determine whether the gears in the parking lock mechanism 30 are engaged to stop the vehicle, and is set close to 0. The processing of steps S170 to S190 waits until the gears in the parking lock mechanism 30 are engaged to stop the vehicle moving after the brake OFF operation. When the vehicle speed V is lower than the preset reference value Vref, the CPU 42 cancels the torque command Tm* of the motor (step S200) and exits from this parking lock control routine. Under the condition of engagement of the gears in the parking lock mechanism 30 at the brake OFF timing, the vehicle is kept at a stop after elapse of the preset time period tref since the brake OFF operation. The CPU 42 thus immediately cancels the torque command Tm* of the motor 22.

In the electric vehicle 20 of the embodiment described above, in response to the brake OFF operation after the gearshift operation of the gearshift lever 51 to the P position, the motor 22 is controlled to output a torque corresponding to the adjusted driving force F* applied in the direction of canceling the vehicle weight force component FM based on the road surface gradient θ. Such control-reduces the force applied in the longitudinal direction of the vehicle and decreases the moving speed of the vehicle. The decreased moving speed of the vehicle enables moderate engagement of the gears in the parking lock mechanism 30 to decrease the potential shock of gear engagement and reduces the driver's feeling of idle running.

In the electric vehicle 20 of the embodiment, the parking lock control process waits for a brake OFF operation. One modified procedure may wait until the driver's depression amount of the brake pedal 55 becomes less than a preset level (for example, the brake pedal position BP=50%).

The electric vehicle 20 of the embodiment drives and controls the motor 22 in response to the brake OFF operation after the gearshift operation of the gearshift lever 51 to the P position, regardless of the time interval between the gearshift operation and the brake OFF operation. One modified procedure may drive and control the motor 22 in response to the brake OFF operation only within a preset time period after the gearshift operation.

The electric vehicle 20 of the embodiment computes the vehicle weight force component FM from the road surface gradient θ detected by the slope sensor 59. The electric vehicle 20 may be provided with a G sensor for detecting the acceleration in the longitudinal direction of the vehicle, in place of or in addition to the slope sensor 59, and may compute the vehicle weight force component FM from the measured value of the G sensor.

In the electric vehicle 20 of the embodiment, the coefficient β is set to increase with an increase in road surface gradient θ as shown in the coefficient setting map of FIG. 3. The coefficient β may be fixed to a preset value in the range of 0 to 1.

In the electric vehicle 20 of the embodiment, the adjusted driving force F* applied in the direction of canceling the vehicle weight force component FM is calculated by multiplying the vehicle weight force component FM by the coefficient β. Another method may be applied to determine the adjusted driving force F* that is smaller than the vehicle weight force component FM and is applied in the direction of canceling the vehicle weight force component FM. One modified procedure may subtract a preset value from the vehicle weight force component FM to set the adjusted driving force F*. The adjusted driving force F* may otherwise be set to make the difference between the adjusted driving force F* and the vehicle weight force component FM equal to a preset value.

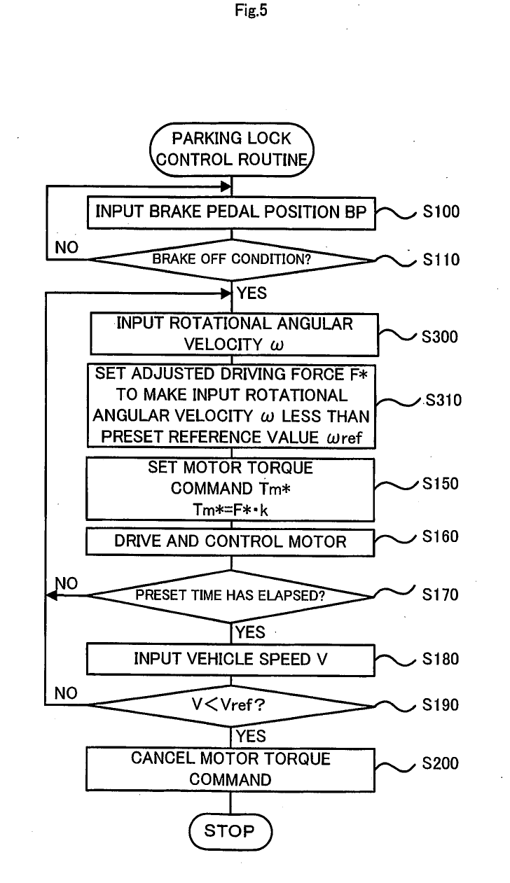

In the electric vehicle 20 of the embodiment, the adjusted driving force F* is calculated from the vehicle weight force component FM based on the road surface gradient θ. The adjusted driving force F* may otherwise be calculated from a rotational angular velocity ω of the rotating shaft 22a of the motor 22 or from the vehicle speed V. A modified parking lock control routine with the former modified calculation is shown in the flowchart of FIG. 5. In response to the brake OFF operation at step S110, this modified parking lock control routine executes the processing of steps S300 and S310, in place of the processing of steps S120 to S140 in the parking lock control routine of FIG. 2. The CPU 42 inputs the rotational angular velocity ω calculated from the rotational angle α of the rotating shaft 22a of the motor 22 or the drive shaft measured by the rotational angle sensor 23 (step S300), and sets the adjusted driving force F* to make the input rotational angular velocity ω less than a preset reference value ωref (step S310). The CPU 42 then executes the processing of and after step S150. The reference value ωref represents a rotational angular velocity to attain the moderate engagement of the gears in the parking lock mechanism 30 and is set to be greater than an angular rotational velocity corresponding to the reference value Vref. This modified parking lock control routine drives and controls the motor 22 to make the rotational angular velocity ω in motion of the vehicle equal to the preset reference value ωref. In the case of a negative answer at either step S170 or step S190, the modified parking lock control routine returns to step S300. In the latter case, that is, in the case of calculating the adjusted driving force F* from the vehicle speed V, the processing of steps S300 and S310 in the modified parking lock control routine of FIG. 5 uses the vehicle speed V, in place of the rotational angular velocity ω, to calculate the adjusted driving force F*. These modified procedures do not require detection of the road surface gradient θ by the slope sensor 59 to calculate the adjusted driving force F*.

The electric vehicle 20 of the embodiment uses the vehicle speed V to determine the timing of canceling the torque command Tm* of the motor 22. The cancellation timing may otherwise be determined according to the rotational angle α of the rotating shaft 22a of the motor 22 or according to the elapse of time since the start of output of the torque corresponding to the adjusted driving force F* from the motor 22. In the former modification, the torque command Tm* may be cancelled when a variation in rotational angle α (current α−previous α) becomes less than a preset reference value αref, which is the criterion for determining whether the gears in the parking lock mechanism 30 are engaged to stop the vehicle. The torque command Tm* may alternatively be cancelled when the rotational angle α is in a specific angle range representing engagement of the gears in the parking lock mechanism 30 and is not changed for a preset time period. In the latter modification, the torque command Tm* may be cancelled when a certain time period expected to attain engagement of the gears in the parking lock mechanism 30 has elapsed since the start of output of the torque corresponding to the adjusted driving force F* from the motor 22.

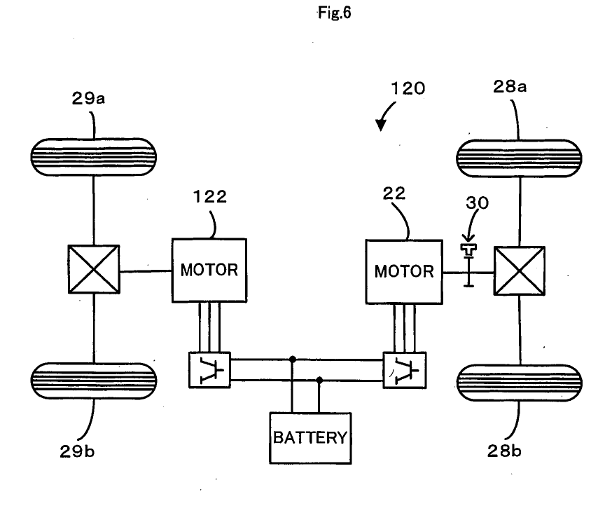

The electric vehicle 20 of the embodiment has the motor 22 that outputs the driving force to the axle linked to the drive wheels 28a and 28b. The technique of the invention is also applicable to another electric vehicle 120 shown in FIG. 6 as a modified example. The electric vehicle 120 has a motor 122 that outputs the driving force to a different axle (that is, an axle linked to wheels 29a and 29b in FIG. 6) from the axle linked to the drive wheels 28a and 28b, in addition to the motor 22. In this modified structure, the motor 122 in combination with or in place of the motor 22 is controlled to output a torque corresponding to the motor torque command Tm* set at step S150 in the parking lock control routine of FIG. 2.

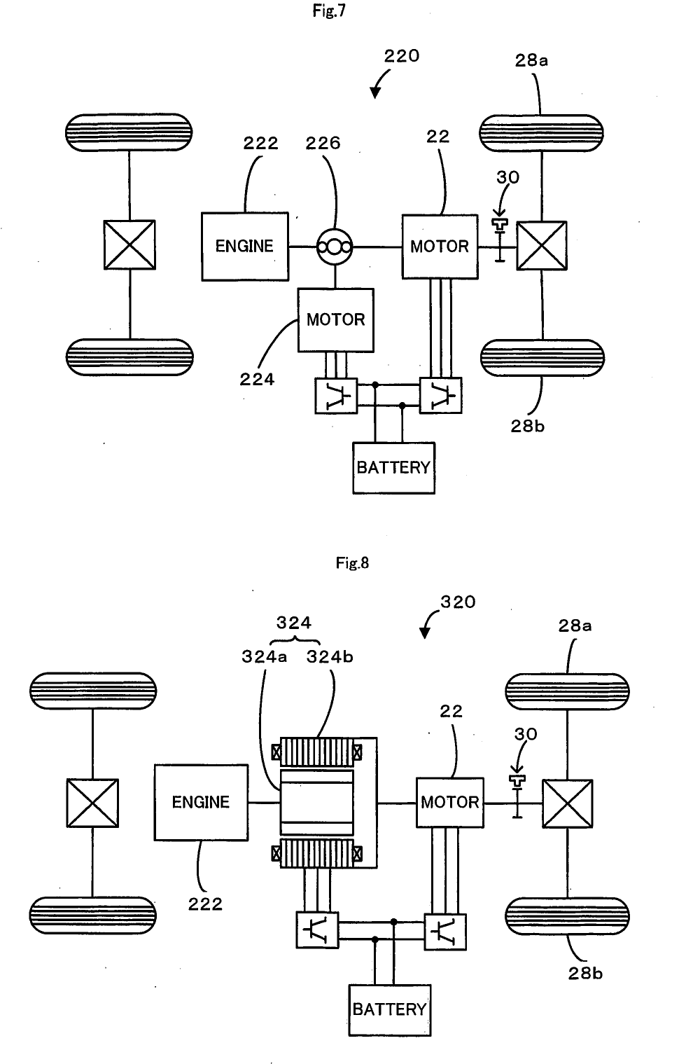

The embodiment regards the electric vehicle 20 equipped with the motor 22 that outputs the driving force to the axle linked to the drive wheels 28a and 28b. The technique of the invention is applicable to a vehicle of any configuration including a motor that outputs the driving force either to the axle linked to the drive wheels 28a and 28b or to the different axle from the axle linked to the drive wheels 28a and 28b. For example, the technique of the invention is applicable to a series hybrid vehicle having an engine, a generator that is connected to an output shaft of the engine, and a motor that uses electric power generated by the generator to output the driving force to the axle linked to the drive wheels 28a and 28b. In another example shown in FIG. 7, the technique of the invention is also applicable to a mechanical distribution-type hybrid vehicle 220 having an engine 222, a planetary gear mechanism 226 that is connected to the engine 222, a motor 224 that is connected with the planetary gear mechanism 226 and is capable of generating electric power, and the motor 22 that is connected with the planetary gear mechanism 226 and with the axle linked to the drive wheels 28a and 28b. In still another example shown in FIG. 8, the technique of the invention is applicable to an electrical distribution-type hybrid vehicle 320 having an engine 222, a motor 324 that includes an inner rotor 324a connected to the engine 222 and an outer rotor 324b connected to the axle linked to the drive wheels 28a and 28b and is rotated relatively through electromagnetic actions of the inner rotor 324a and the outer rotor 324b, and the motor 22 that is connected to the axle linked to the drive wheels 28a and 28b.

The embodiment and its modified examples discussed above are to be considered in all aspects as illustrative and not restrictive. There may be many other modifications, changes, and alterations without departing from the scope or spirit of the main characteristics of the present invention.

### INDUSTRIAL APPLICABILITY

The present invention is preferably applicable to automobile manufacturing industries.

1. A motor vehicle, comprising:
a motor that outputs driving force to drive said motor vehicle;
a locking structure that utilizes gear engagement to lock an axle of said motor vehicle in a non-rotatable state;
an adjusted driving force setting module that sets an adjusted driving force, which is smaller than a vehicle weight force component or a force component of a vehicle weight acting in a longitudinal direction of said motor vehicle based on a road surface gradient and is applied in a direction of canceling the vehicle weight force component; and
a control module that, when a driver's depression amount of a brake pedal becomes less than a preset level to move said motor vehicle in the acting direction of the vehicle weight force component after a gearshift operation of a gearshift lever to a parking position, controls the motor to output the adjusted driving force and controls the locking structure to lock the axle.

2. A motor vehicle in accordance with claim 1, wherein said control module controls the motor to output the adjusted driving force when the driver's depression amount of the brake pedal becomes less than the preset level within a predetermined time period since the gearshift operation of the gearshift lever to the parking position.

3. A motor vehicle in accordance with claim 1, wherein said control module controls the motor to terminate the output of the adjusted driving force when a predetermined condition is satisfied.

4. A motor vehicle in accordance with claim 3, wherein the predetermined condition is that a measured vehicle speed of said motor vehicle becomes less than a preset vehicle speed.

5. A motor vehicle in accordance with claim 3, wherein the predetermined condition is that a rotational angle of a drive shaft linked to the axle is kept unchanged in a specified angle range.

6. A motor vehicle in accordance with claim 1, wherein said adjusted driving force setting module measures the road surface gradient and sets the adjusted driving force to increase with an increase in measured road surface gradient.

7. A motor vehicle in accordance with claim 1, wherein said adjusted driving force setting module measures the vehicle weight force component and sets the adjusted driving force to increase with an increase in measured vehicle weight force component.

8. A motor vehicle in accordance with claim 1, said motor vehicle further comprising:
a second motor that outputs driving force to a different axle from the axle receiving the driving force output from the motor,
wherein said control module controls the motor and the second motor to cooperatively output the adjusted driving force.

9. A motor vehicle, comprising:
multiple motors that output driving force to an identical axle or to different axles to drive said motor vehicle;
a locking structure that utilizes gear engagement to lock an axle of said motor vehicle in a non-rotatable state;
an adjusted driving force setting module that sets an adjusted driving force, which is smaller than a vehicle weight force component or a force component of a vehicle weight acting in a longitudinal direction of said motor vehicle based on a road surface gradient and is applied in a direction of canceling the vehicle weight force component; and
a control module that, when a driver's depression amount of a brake pedal becomes less than a preset level to move said motor vehicle in the acting direction of the vehicle weight force component after a gearshift operation of a gearshift lever to a parking position, controls the multiple motors to ensure output of the adjusted driving force from at least one of the multiple motors and controls the locking structure to lock the axle.

10. A control method of a motor vehicle equipped with a motor that outputs driving force to drive said motor vehicle and a locking structure that utilizes gear engagement to lock an axle of said motor vehicle in a non-rotatable state,
said control method comprising the steps of:
(a) setting an adjusted driving force, which is smaller than a vehicle weight force component or a force component of a vehicle weight acting in a longitudinal direction of said motor vehicle based on a road surface gradient and is applied in a direction of canceling the vehicle weight force component; and
(b) when a driver's depression amount of a brake pedal becomes less than a preset level to move said motor vehicle in the acting direction of the vehicle weight force component after a gearshift operation of a gearshift lever to a parking position, controlling the motor to output the adjusted driving force and controlling the locking structure to lock the axle.

11. A control method of a motor vehicle in accordance with claim 10, wherein said step (b) controls the motor to output the adjusted driving force when the driver's depression amount of the brake pedal becomes less than the preset level within a predetermined time period since the gearshift operation of the gearshift lever to the parking position.

12. A control method of a motor vehicle in accordance with claim 10, wherein said step (b) controls the motor to terminate the output of the adjusted driving force when a predetermined condition is satisfied.

13. A control method of a motor vehicle in accordance with claim 10, wherein said step (a) measures the road surface gradient and sets the adjusted driving force to increase with an increase in measured road surface gradient.

14. A control method of a motor vehicle in accordance with claim 10, wherein said step (a) measures the vehicle weight force component and sets the adjusted driving force to increase with an increase in measured vehicle weight force component.

15. A control method of a motor vehicle equipped with multiple motors that output driving force to an identical axle or to different axles to drive said motor vehicle and a locking structure that utilizes gear engagement to lock an axle of said motor vehicle in a non-rotatable state,
said control method comprising the steps of:
(a) setting an adjusted driving force, which is smaller than a vehicle weight force component or a force component of a vehicle weight acting in a longitudinal direction of said motor vehicle based on a road surface gradient and is applied in a direction of canceling the vehicle weight force component; and
(b) when a driver's depression amount of a brake pedal becomes less than a preset level to move said motor vehicle in the acting direction of the vehicle weight force component after a gearshift operation of a gearshift lever to a parking position, controlling the multiple motors to ensure output of the adjusted driving force from at least one of the multiple motors and controlling the locking structure to lock the axle.
